(19) United States
(12) Patent Application Publication
(10) Pub. No.: US 2012/0313916 A1
(43) Pub. Date: Dec. 13, 2012

(54) DISPLAY APPARATUS AND METHOD OF DRIVING THE SAME

(75) Inventor: Hyun-chul SONG, Suwon-si (KR)

(73) Assignee: SAMSUNG ELECTRONICS CO., LTD., Suwon-si (KR)

(21) Appl. No.: 13/348,678

(22) Filed: Jan. 12, 2012

(30) Foreign Application Priority Data
Jun. 8, 2011 (KR) 2011-0055311

(51) Int. Cl. G09G 5/00; G09G 3/28

(52) U.S. Cl. 345/211; 345/60

(57) ABSTRACT

A display apparatus includes a plasma display panel comprising a scan electrode, a sustain electrode, and an address electrode, an integrated driver applying a driving voltage to the scan electrode and the sustain electrode, a data driver applying a driving voltage to the address electrode, and a controller applying a sustain pulse to the scan electrode and the sustain electrode and applying a predetermined constant voltage or higher to the address electrode in a sustain period.

### CROSS-REFERENCE TO RELATED PATENT APPLICATION

This application claims from the benefit of Korean Patent Application No. 10-2011-0055311, filed on Jun. 8, 2011, in the Korean Intellectual Property Office, the contents of which are incorporated herein by reference in its entirety.

### BACKGROUND

1. Field

The present general inventive concept relates to a display apparatus and a method of driving the same, and more particularly, to a display apparatus using a plasma display panel and a method of driving the same.

2. Description of the Related Art

Currently, flat panel display apparatuses such as liquid crystal displays (LCDs), field emission displays (FEDs), plasma display panels (PDPs), and the like, are being developed. Among the above flat panel display apparatuses, a plasma display panel (hereinafter, referred to as PDP) has advantages of high luminance, high light efficiency, and a wider viewing angle than the other flat panel display apparatuses. Thus, a PDP is in the spotlight as a display apparatus to replace a conventional CRT(Cathode Ray Tube) in a display apparatus with a large screen of 40 inch or larger.

A PDP is a flat panel display apparatus using light generated by sending an electrical discharge through an ionized gas, that is, a plasma, to display text or graphics. The PDP may be divided largely into a DC (Direct Current) type and an AC(Alternating Current) type, and a surface-discharge AC type based on an ADS (Address Display-period Separation) driving system is being widely commercialized.

The AC PDP has a structure in which several cells are arranged in a matrix form and each cell is surrounded by a front substrate, a rear substrate and barrier bars, having three electrodes (scan electrode, sustain electrode, and address electrode), and is generally driven by the ADS driving system lighting the cell by applying a voltage to each electrode.

The ADS driving system is a system driving each subfield by dividing into a reset period, an address period, and a sustain period. In the reset period, the existing sustain discharge of a wall charge is removed, and a wall charge is set up to stably perform a next address discharge. In the address period, cells are determined to be turned-on or turned-off, and wall charge is accumulated on the turned-on cells (addressed cells). In the sustain period, discharging is executed to display an image on the addressed cells by alternately applying a sustain voltage to the scan electrode and the sustain electrode.

FIGS. 1A and 1B are diagrams provided to explain problems of a conventional technology. Referring to FIG. 1A, when a sustain waveform is applied to an X driving board, a loop in which an X sustain noise goes through a panel and returns through a Yg switch on the Y driving board. Accordingly, a return path of a sustain waveform is formed through the chasis base, and then, the sustain noise is abandoned on the chasis base, thereafter abandoned on an imaging board coupled to the chasis base, and is represented on a screen. Also, when a sustain waveform is applied to a Y driving board, a sustain noise is abandoned on the chasis base by forming a loop in which a Y sustain noise returns through the Xg switch on the X driving board.

FIG. 1B shows driving waveforms in a sustain period of a conventional display panel. Referring to FIG. 1B, a sustain pulse is applied to the X electrode and the Y electrode by turns in the sustain period, and the address electrode is maintained as 0V, which means, the sustain noise may be abandoned to the chasis base through the address electrode.

To solve the above problem, Braket-PCB, ring core, Gsket, or the like, was used, however, this also caused a problem that additional costs may be generated by applying such additional devices.

### SUMMARY

An aspect of exemplary embodiments provides a display apparatus capable of reducing a sustain noise by controlling an electrode driving signal which is applied to a panel, and a method of driving the same.

Additional aspects and utilities of the present general inventive concept will be set forth in part in the description which follows and, in part, will be obvious from the description, or may be learned by practice of the general inventive concept.

The foregoing and/or other aspects and utilities may be achieved by providing a display apparatus including a plasma display panel having a scan electrode, a sustain electrode, and an address electrode, an integrated driver applying a driving voltage to the scan electrode and the sustain electrode, a data driver applying a driving voltage to the address electrode, and a controller controlling to apply a sustain pulse to the scan electrode and the sustain electrode during a sustain period and to apply a constant voltage of a predetermined level or a voltage level higher than the predetermined level to the address electrode.

The integrated driver may drive the scan electrode and the sustain electrode integratedly.

The integrated driver may apply a plurality of driving signals to the corresponding plurality of the scan electrodes, respectively, and apply a single driving signal to the sustain electrode.

The scan electrodes and the sustain electrodes may be formed in pairs and arranged alternatingly with each other, and the address electrodes may be formed to intersect the scan electrodes and the sustain electrodes.

A return path of a driving waveform of the scan electrode be formed on the sustain electrode and a return path of a driving waveform of the sustain electrode may be formed on the scan electrode.

The foregoing and/or other aspects and utilities of exemplary embodiments may be achieved by providing a method of driving a display apparatus, which includes a plasma display panel having a scan electrode, a sustain electrode and an address electrode, including steps of applying an integrated driving voltage to the scan electrode and the sustain electrode, applying a driving voltage to the address electrode, and during a sustain period, applying a sustain pulse to the scan electrode and the sustain electrode, and applying a predetermined constant voltage or a voltage higher than the predetermined constant voltage to the address electrode.

The step of applying an integrated driving voltage may include applying a plurality of driving signals to the corresponding plurality of the scan electrodes, respectively, and applying a signal driving signal to the sustain electrode.

The scan electrodes and the sustain electrodes may be formed in pairs and arranged alternatingly with each other, and the address electrodes may be formed to intersect the scan electrode and the sustain electrode in the plasma display panel.

A return path of a driving waveform of the scan electrode may be formed on the sustain electrode and a return path of a driving waveform of the sustain electrode may be formed on the scan electrode.

Accordingly, a sustain noise may be decreased by controlling electrode driving signals applied to the panel, therefore, additional devices are not demanded.

### BRIEF DESCRIPTION OF THE DRAWINGS

These and/or other aspects and utilities of exemplary embodiments will become apparent and more readily appreciated from the following description of the exemplary embodiments, taken in conjunction with the accompanying drawings of which:

FIGS. 1A and 1B are diagrams provided to explain problems in accordance with a conventional technology;

FIG. 2 is a partial perspective view of a display panel according to an exemplary embodiment;

FIG. 3 is a block diagram illustrating a structure of a display apparatus according to an exemplary embodiment;

FIGS. 4A and 4B are diagrams illustrating a structure of a display panel according to an exemplary embodiment;

FIG. 5 is a diagram illustrating a structure of a display apparatus according to an exemplary embodiment;

FIG. 6 illustrates a waveform of each electrode according to an exemplary embodiment; and

FIG. 7 a flow chart to explain a method for driving the display apparatus according to an exemplary embodiment.

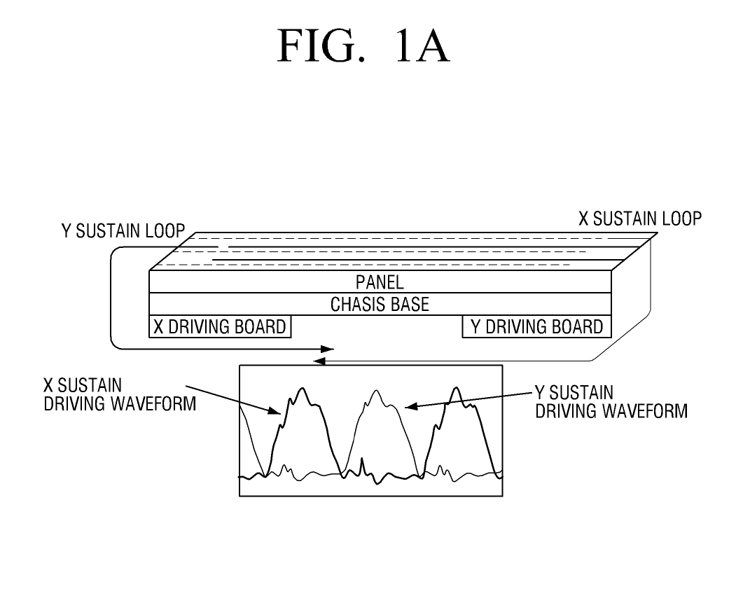

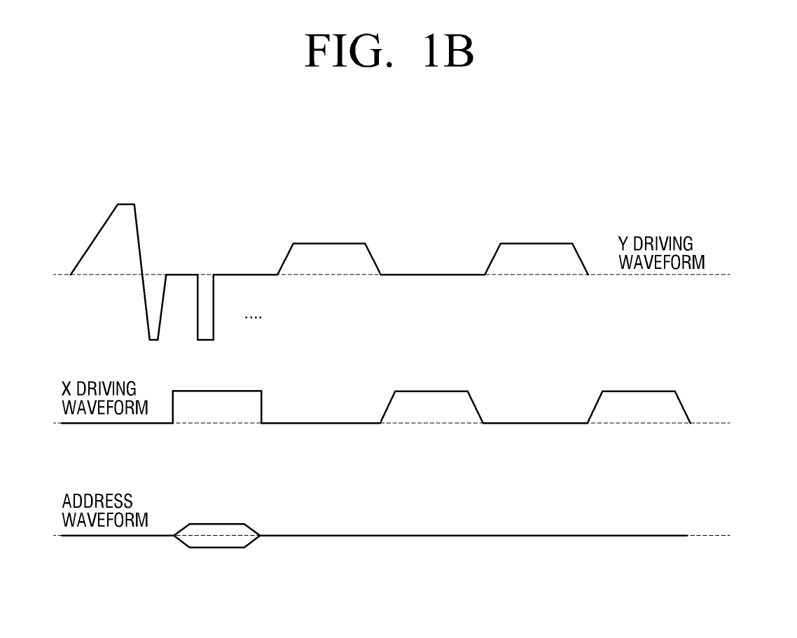

### DETAILED DESCRIPTION OF EXEMPLARY EMBODIMENTS

Reference will now be made in detail to the exemplary embodiments, examples of which are illustrated in the accompanying drawings, wherein like reference numerals refer to the like elements throughout. The exemplary embodiments are described below sequentially by referring to the figures.

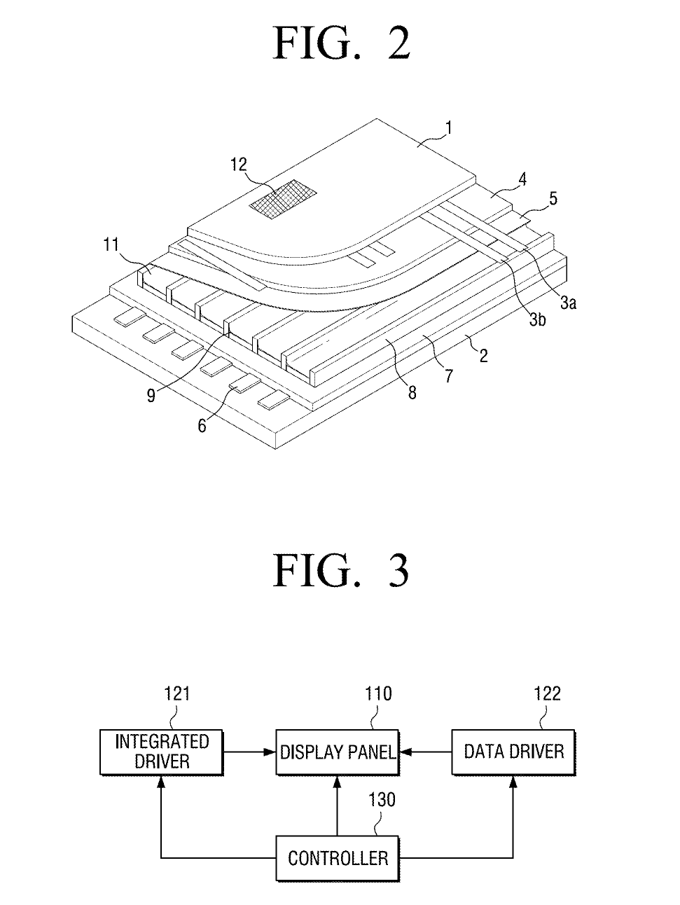

FIG. 2 is a partial perspective view of a display panel provided to help understand the present invention according to an exemplary embodiment. For example, the display panel shown in FIG. 2 may be the plasma display panel of AC (Alternative Current) type.

The plasma display panel includes two insulating substrates 1, 2 facing with each other from a distance. A plurality of scan electrodes 3a and a plurality of sustain electrodes 3b are formed in pairs and arranged in parallel under the insulating substrate 1, and the scan electrode 3a and the sustain electrode 3b are covered with a dielectric layer 4 and a protective layer 5. Barrier ribs 8 are formed on insulating layer 7 between two address electrodes 6, and the phosphors 9 are formed on the surface of the insulating layer 7 and both sides of the barrier ribs 8.

The insulating substrates 1, 2 face with each other so that a discharge space 11 is formed therebetween so that the address electrodes 6 may intersect with the scan electrodes 3a and the sustain electrodes 3b. The discharge space which is formed in the cross border between the address electrode 6 and a pair of the scan electrode 3a and the sustain electrode 3b forms a discharge cell 12.

Here, wall charge represents charge formed on the wall (for example, dielectric layer) of nearest discharge cell from each electrode and accumulated on the electrode. Although the wall charge may not contact the electrode itself, it may be described that wall charge “is formed”, “is accumulated” or “is piled”. And, a wall voltage represents potential difference formed on the wall of the discharge cell by the wall charge.

Barrier ribs prevent a cross talk of neighboring pixels by blocking out light generated at discharging as well as forming a discharge space.

The unit structure is formed on a substrate in a matrix form in plural, and the phosphors are applied on each unit structure to form a pixel. The cluster of pixels makes a plasma display panel. In the presently commercialized plasma display panel, electric discharge is generated in each pixel, thus exiting the phosphors coated on the inside walls of the pixel with ultraviolet rays generated by the electric discharge so as to emit a desired color.

FIG. 3 is a block diagram illustrating a structure of a display apparatus according to an exemplary embodiment. Referring to FIG. 3, the display apparatus includes a display panel 110, an integrated driver 121, a data driver 122, and a controller 130.

The display panel 110 may be implemented as a plasma display panel comprising a scan electrode, a sustain electrode, and an address electrode. At this time, the plasma display panel has a structure that the scan electrodes and the sustain electrodes are formed in a pair and are arranged alternatively with each other, and the address electrodes are formed to intersect the scan electrode and the sustain electrode.

The integrated driver 121 applies a driving voltage to the scan electrode and the sustain electrode.

The data driver 122 applies a driving voltage to the address electrode.

Also, the integrated driver 121 performs an integrated driving of the scan electrode and the sustain electrode.

Also, the integrated driver 121 applies a plurality of driving signals to the corresponding plurality of the scan electrodes, respectively, and a single driving signal to the sustain electrode.

The controller 130 controls the integrated driver 121 and the data driver 122 to apply a sustain pulse to the scan electrode and the sustain electrode and a predetermined constant voltage or higher to the address electrode during a sustain period.

Accordingly, a return path of a driving waveform of the scan electrode is formed on the sustain electrode, and a return path of a driving waveform of the sustain electrode is formed on the scan electrode.

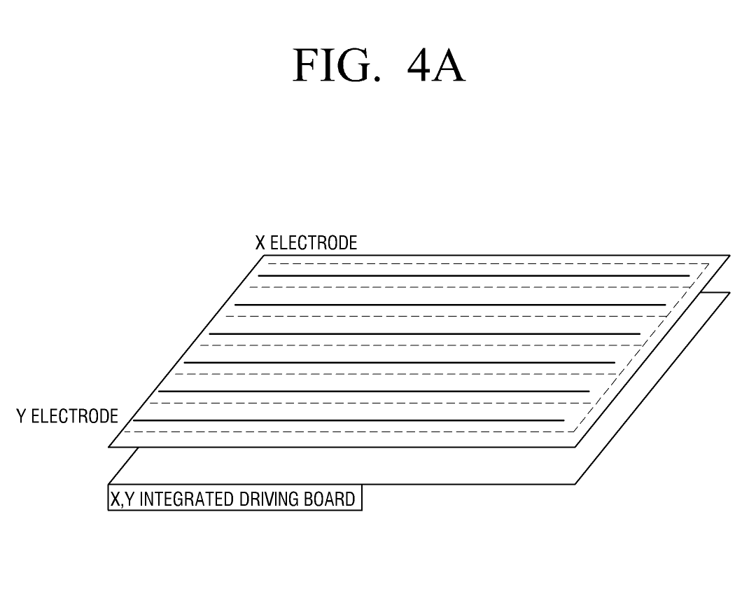

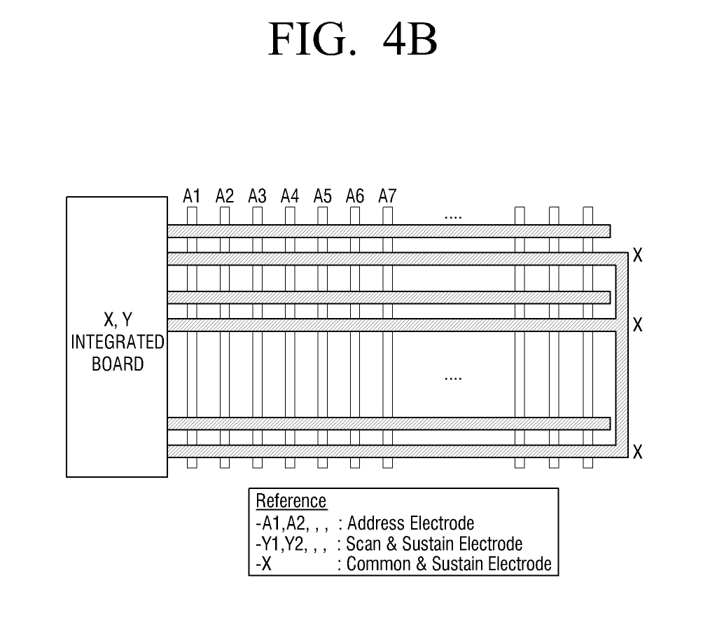

FIGS. 4A and 4B are diagrams provided to explain a structure of a display panel according to an exemplary embodiment. Referring to FIGS. 4A and 4B, an integrated circuit board is used to control both a first sustain electrode and a second sustain electrode. For example, the integrated circuit board generates a plurality of driving signals corresponding to the plurality of the scan electrodes (Y1 through Yn), respectively, provides the signals with the scan electrodes, generates a single driving signal corresponding to the sustain electrode and provides the signal with the sustain electrode.

Meanwhile, as shown in FIG. 4B, a plasma display panel has a structure of n×m matrix. The address electrodes A1-An are disposed in a row direction and n pairs of the scan electrodes Y1-Yn and the sustain electrodes X1-Xn are disposed in a lineal direction.

The plasma display panel is required to embody a gray scale to perform a color display, and a method for embodying the same is time division controlling by dividing one TV field into a plurality of subfields. The detailed description on this is omitted.

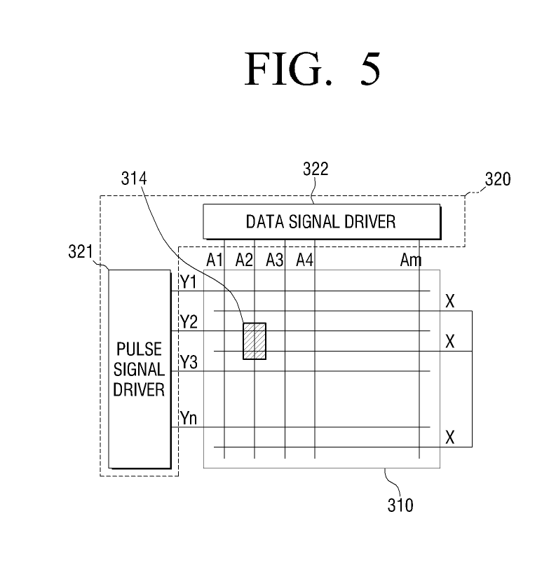

FIG. 5 is a diagram illustrating a structure of a display apparatus according to an exemplary embodiment.

A display panel 310 includes a plurality of data electrodes A1-Am disposed in a row direction and a plurality of sustain electrodes X1-Xn and scan electrodes Y1-Yn disposed in a lineal direction. X electrodes X1-Xn are formed to correspond to each of Y electrodes Y1-Yn and generally connected in their one ends in common.

And the plasma display panel 310 is composed of a glass substrate (not shown) on which the X electrodes and the Y electrodes are disposed and a glass substrate (not shown) on which the address electrodes A1-Am are disposed. The two glass substrates are arranged to face each other so that discharge space is generated therebetween such that the address electrodes A1-Am are formed to intersect the Y electrodes Y1-Yn and the X electrodes X1-Xn. The discharge space formed in the cross border between the address electrodes A1-An and pairs of the Y electrodes Y1-Yn and the X electrodes X1-Xn forms a discharge cell 314. At this time, the display panel 310 may be implemented as a plasma display panel.

The driving unit 320 applies a driving signal to each electrode of the plasma display panel 310. Each driving signal may be a constant voltage signal or a pulse signal. Specifically, the driving unit 320 includes a pulse signal driver 321 to drive a first and a second sustain electrodes and a data signal driver 322 to drive the address electrode. Here, the first and the second sustain electrodes may be a sustain electrode and a scan electrode.

The pulse signal driver 321 applies a pulse signal to the first and the second sustain electrodes in a sustain period. Specifically, the pulse signal driver 321 applies a pulse signal such that a pulse may arise in the first and the second sustain electrodes alternatively. More specifically, the pulse signal driver 321 may drive the scan electrodes and the sustain electrodes integratedly by applying a plurality of driving signals to the corresponding plurality of the scan electrodes, respectively, and a single driving signal to the sustain electrode.

The data signal driver 322 applies a predetermined constant voltage or higher to the address electrode, for example, applies Va.

Although it is not shown FIG. 5, the display apparatus includes a chasis base to support the display panel and a plurality of PCBs (Printed Circuit Boards) installed on the chasis base and connected to the display panel 310.

The scan electrode, the sustain electrode and the address electrode are connected to related PCBs through a FPC (Flexible Printed Circuit). For example, the PCB may include an integrated board controlling the scan electrode and the sustain electrode and an address board controlling the address electrode.

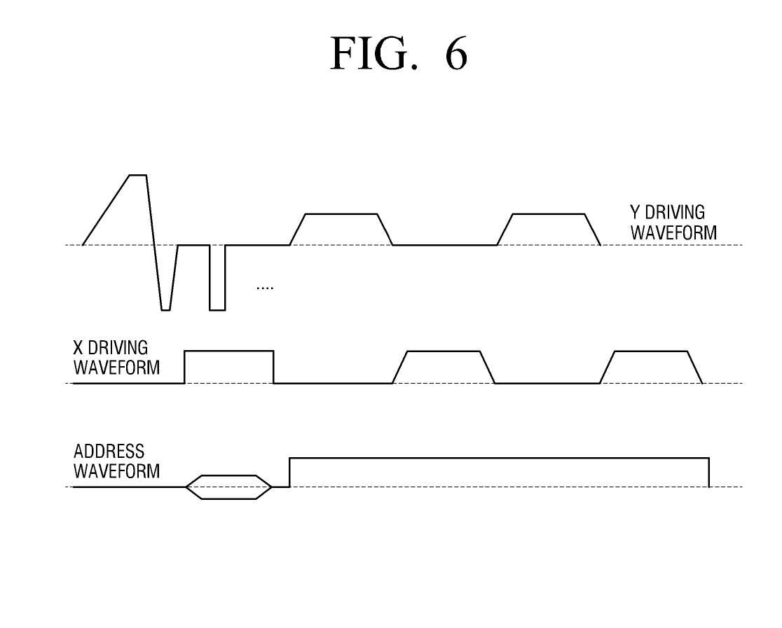

FIG. 6 illustrates a waveform of each electrode according to an exemplary embodiment. Referring to FIG. 6, a Y electrode (scan electrode) receives a pulse voltage, an X electrode (sustain electrode) receives a pulse voltage of an alternative form with the pulse voltage applied to the Y electrode, and an address electrode receives a constant voltage Va. That is, the X and Y electrodes are driven integratedly, and potential of the address electrode is maintained as Va, so that a return path of the X driving waveform is formed on the Y electrode and a return path of the Y driving waveform is formed on the X electrode, which results in preventing a sustain noise from being abandoned in a chasis base.

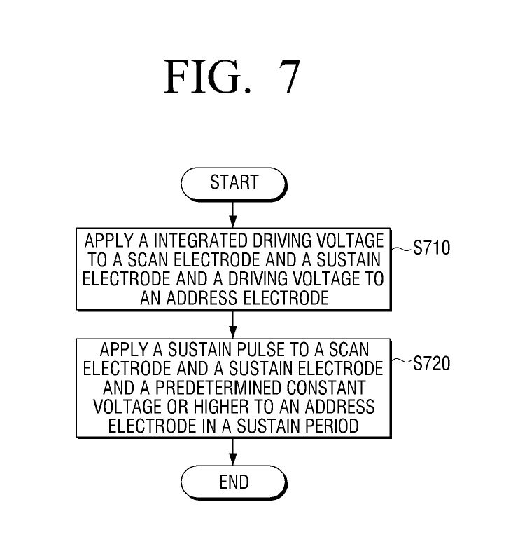

FIG. 7 is a flow chart to explain a method of driving a display apparatus according to an exemplary embodiment of the present invention. Referring to FIG. 7, the method of driving the display apparatus including a plasma display panel which has a scan electrode, a sustain electrode and an address electrode includes a step of applying an integrated driving voltage to the scan electrode and the sustain electrode and a driving voltage to the address electrode (S710). At this time, the plasma display panel has a structure that the scan electrode and the sustain electrode are disposed alternatingly with each other forming in a pair and the address electrode is disposed to intersect to the scan electrode and the sustain electrode.

Next step is applying a sustain pulse to the scan electrode and the sustain electrode during a sustain period and a predetermined constant voltage or higher to the address electrode (S710).

When the integrated driving voltage is applied, a plurality of driving signals are applied to the corresponding plurality of the scan electrodes, respectively, and a single driving signal are applied to the sustain electrode. Accordingly, a return path of driving waveform of the scan electrode is formed on the sustain electrode and a return path of driving waveform of the sustain electrode is formed on the scan electrode.

As described above, according to exemplary embodiments, potential on the scan electrode and the sustain electrode is maintained constantly in a sustain discharge period, which results in restraining vibration of the panel and accordingly, reducing noise.

Although a few exemplary embodiments have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising:
a plasma display panel configured to include a scan electrode, a sustain electrode, and an address electrode;
an integrated driver configured to apply a driving voltage to the scan electrode and the sustain electrode;
a data driver configured to apply a driving voltage to the address electrode; and
a controller configured to control to apply a sustain pulse to the scan electrode and the sustain electrode during a sustain period and a predetermined constant voltage or a voltage higher than the predetermined constant voltage to the address electrode.

2. The display apparatus of claim 1, wherein the integrated driver is configured to drive the scan electrode and the sustain electrode integratedly.

3. The display apparatus of claim 2, wherein the integrated driver is configured to apply a plurality of driving signals to a corresponding plurality of the scan electrodes, respectively, and apply a single driving signal to the sustain electrode.

4. The display apparatus of claim 1, wherein the plasma display panel has a structure that scan electrodes and sustain electrodes are formed in pairs and arranged alternatingly with each other, and address electrodes are formed to intersect with the scan electrodes and the sustain electrodes.

5. The display apparatus of claim 1, wherein a return path of a driving waveform of the scan electrode is formed on the sustain electrode, and a return path of a driving waveform of the sustain electrode is formed on the scan electrode.

6. A method of driving a display apparatus including a plasma display panel comprising a scan electrode, a sustain electrode, and an address electrode, the method comprising:
applying an integrated driving voltage to the scan electrode and the sustain electrode, and applying a driving voltage to the address electrode; and
applying a sustain pulse to the scan electrode and the sustain electrode and a predetermined constant voltage or a level higher than the predetermined constant voltage to the address electrode during a sustain period.

7. The method of claim 6, wherein the applying an integrated driving voltage comprises applying a plurality of driving signals to a plurality of corresponding scan electrodes, respectively, and applying a single driving signal to the sustain electrode.

8. The method of claim 6, wherein the plasma display panel has a structure that scan electrodes and sustain electrodes are formed in pairs and arranged alternatingly with each other, and address electrodes are formed to intersect with the scan electrodes and the sustain electrodes.

9. The method of claim 6, wherein a return path of a driving waveform of the scan electrode is formed on the sustain electrode, and a return path of a driving waveform of the sustain electrode is formed on the scan electrode.
